(19) United States
(12) Patent Application Publication
(10) Pub. No.: US 2026/0180034 A1
(43) Pub. Date: Jun. 25, 2026

(54) CELL AND ELECTRICAL DEVICE

(71) Applicant: Ningde Amperex Technology Limited, Ningde (CN)

(72) Inventors: Chenchen LI, Ningde (CN); Hua WU, Ningde (CN)

(73) Assignee: Ningde Amperex Technology Limited, Ningde (CN)

(21) Appl. No.: 19/428,630

(22) Filed: Dec. 22, 2025

(30) Foreign Application Priority Data
Dec. 24, 2024 (CN) 202411918269.8

(51) Int. Cl. H01M 10/0587; H01M 4/38

(52) U.S. Cl. CPC H01M 10/0587; H01M 4/386

(57) ABSTRACT

A cell including an electrode assembly, and the electrode assembly being formed by winding a positive electrode plate, a separator, and a negative electrode plate stacked. A negative active material of the negative electrode plate includes a silicon-based material, and two surfaces of the negative current collector are completely coated with the negative active material. At a first straight section, a first corner section, and a second straight section of an innermost turn of the positive electrode plate, two surfaces of the positive current collector are coated with a positive active material. An innermost turn of the negative electrode plate includes a third straight section, a second corner section, and a fourth straight section. The first straight section is located between the third straight section and the fourth straight section, and the third straight section is located between the first straight section and the second straight section.

### CROSS-REFERENCE TO RELATED APPLICATION

This application claims priority to the Chinese Patent Application Serial No. 202411918269.8, filed on Dec. 24, 2024, the content of which is incorporated herein by reference in its entirety.

### TECHNICAL FIELD

This application relates to the technical field of batteries, and in particular, to a cell and an electrical device.

### BACKGROUND

With the rapid development of electronic information technology, various electronic devices are also evolving towards directions of intelligence and multifunctionality, placing increasingly higher demands on the energy density of batteries.

Batteries with silicon-based negative electrodes are favored for high energy density, but an expansion rate of the battery is relatively high, thereby causing fractures between the double-sided coated regions and single-sided coated regions of the negative electrode plate, as well as between the single-sided coated regions and double-sided empty foil regions thereof due to different expansion forces, further leading to metal ion precipitation, and affecting the battery's service life.

### SUMMARY

This application provides a cell and an electrical device, which can improve the service life of the cell.

In a first aspect, this application provides a cell, the cell including an electrode assembly, and the electrode assembly being formed by winding a positive electrode plate, a separator, and a negative electrode plate which are stacked. The negative electrode plate includes a negative current collector and a negative active material, the negative active material includes a silicon-based material, and two surfaces of the negative current collector are configured to be completely coated with the negative active material. An innermost turn of the positive electrode plate includes a first straight section, a first corner section, and a second straight section, the first corner section connects the first straight section and the second straight section, and an end that is of the first straight section and that is away from the first corner section serves as a winding starting end of the positive electrode plate. The positive electrode plate includes a positive current collector and a positive active material, and in the first straight section, the first corner section, and the second straight section, two surfaces of the positive current collector are coated with the positive active material. An innermost turn of the negative electrode plate includes a third straight section, a second corner section, and a fourth straight section, the second corner section connects the third straight section and the fourth straight section, and an end that is of the third straight section and that is away from the second corner section serves as a winding starting end of the negative electrode plate. Along a thickness direction of the electrode assembly, the first straight section is located between the third straight section and the fourth straight section, and the third straight section is located between the first straight section and the second straight section.

In the above technical solution, by enabling the negative electrode plate to include the negative current collector and the negative active material, and the negative active material to include the silicon-based material, the negative electrode material can accommodate more metal ions, rendering higher energy density of the cell. By completely coating the negative active material on two surfaces of the negative current collector, the difference in expansion forces exerted on various parts of the negative current collector is relatively small when the negative active material expands, which can reduce the possibility of fracture caused by uneven stress on the negative current collector, thereby decreasing the possibility of metal ion precipitation due to the fracture of the negative current collector, thereby being conducive to improving the service life of the cell. Moreover, the coating process of the negative active material does not require type change, which can enhance the efficiency of the coating process. Two surfaces of the negative current collector are configured to be completely coated with the negative active material. At the first straight section, the first corner section, and the second straight section, two surfaces of the positive current collector are coated with the positive active material. Along the thickness direction of the electrode assembly, the first straight section is located between the third straight section and the fourth straight section, and the third straight section is positioned between the first straight section and the second straight section, so that the positive active material in the first straight section and the second straight section, and the negative active material in the third straight section and the fourth straight section can all be used for intercalation and deintercalation of metal ions. As a result, the volume proportion of both the positive active material and the negative active material are increased, and the utilization rate is higher, thereby being conducive to improving the energy density of the cell.

In some embodiments of this application, in the negative active material, a mass percentage content of the silicon-based material is 4%-100%.

In the above technical solution, by setting the mass percentage content of the silicon-based material in the negative active material to be 4%-100%, the negative electrode material can accommodate more metal ions, thereby increasing the energy density of the cell.

In some embodiments of this application, the positive electrode plate includes a double-sided coated region and a single-sided coated region, one end of the double-sided coated region serves as the winding starting end of the positive electrode plate, and the other end is connected to the single-sided coated region. The single-sided coated region is located on an outer side of an outermost turn of the negative electrode plate, and a side that is of the single-sided coated region and that faces the negative electrode plate is coated with the positive active material.

In the above technical solution, by making the positive electrode plate include a double-sided coated region and a single-sided coated region, with one end of the double-sided coated region serving as the winding starting end of the positive electrode plate and the other end being connected to the single-sided coated region, the positive active material in the double-sided coated region can cooperate with the corresponding negative active material to achieve the intercalation and deintercalation of metal ions. The double-sided coated region is conducive to increasing the volume proportion of the positive active material, thereby being conducive to improving the energy density of the cell. Since the single-sided coated region is located on the outer side of the outermost turn of the negative electrode plate, and the positive active material is disposed on the side that is of the single-sided coated region and that faces the negative electrode plate, i.e., there is no negative active material on the outer side of the single-sided coated region, so the arrangement of the single-sided coated region enables the positive active material on the inner side of the single-sided coated region to cooperate with the negative active material located on the outer side of the outermost turn of the negative electrode plate to achieve the intercalation and deintercalation of metal ions. Moreover, the absence of positive active material on the outer side of the single-sided coated region can improve the utilization rate of the positive active material and can reduce the overall thickness of the cell, which is conducive to increasing the energy density of the cell.

In some embodiments of this application, the positive electrode plate further includes a double-sided empty foil region, with one end of the double-sided empty foil region being connected to the single-sided coated region and the other end serving as a winding tail end of the positive electrode plate.

In the above technical solution, by enabling the positive electrode plate to further include the double-sided empty foil region, where one end of the double-sided empty foil region is connected to the single-sided coated region and the other end serves as the winding tail end of the positive electrode plate, it can be conducive to winding up and securing through the double-sided empty foil region.

In some embodiments of this application, the cell includes a first adhesive tape, and the first adhesive tape is attached to an inner surface of the first corner section.

In the above technical solution, since the first corner section corresponds to the winding starting end of the negative electrode plate, the metal ions deintercalated from the positive active material on the inner side of the first corner section lack sufficient corresponding negative active material for intercalation. Therefore, by including the first adhesive tape in the cell and attaching the first adhesive tape to the inner surface of the first corner section, the first adhesive tape can cover the positive active material on the inner side of the first corner section, reducing the possibility of metal ion precipitation at the first corner section, which is conducive to extending the service life of the cell. Moreover, the first adhesive tape covers the inner side of the first corner section, which can mitigate the risk of powder shedding caused by bending at the first corner section. The first adhesive tape can also provide insulation between the winding starting end of the negative electrode plate and the first corner section, reducing the possibility of short circuit caused by contact between the negative electrode plate and the positive electrode plate, which is conducive to improving the safety of the cell.

In some embodiments of this application, along the thickness direction of the electrode assembly, a projection of the first adhesive tape and a projection of the third straight section have an overlap region. Along a first direction, the length of the overlap region is L1, satisfying 2 mm≤L1≤5 mm. The first direction, the thickness direction of the electrode assembly, and the winding axis direction of the electrode assembly are mutually perpendicular.

In the above technical solution, by enabling the projection of the first adhesive tape and the projection of the third straight section to have the overlap region along the thickness direction of the electrode assembly, the area of the positive active material covered by the first adhesive tape corresponding to the winding starting end of the negative electrode plate is larger, thereby further reducing the possibility of metal ion precipitation in the first corner section, which is conducive to extending the service life of the cell.

When L1 is greater than or equal to 2 mm, the area of the positive active material covered by the first adhesive tape can be larger, further reducing the possibility of metal ion precipitation at the first corner section, which is conducive to prolonging the service life of the cell. When L1 is less than or equal to 5 mm, a space occupied by the first adhesive tape can be smaller, thereby being conducive to reducing an overall volume of the electrode assembly and improving the energy density of the cell. Therefore, when 2 mm≤L1≤5 mm, it can not only reduce the possibility of metal ion precipitation at the first corner section, which is conducive to extending the service life of the cell, but also improve the energy density of the cell.

In some embodiments of this application, the inner surface of the first corner section is provided with a first groove, and at least a portion of the first adhesive tape is accommodated in the first groove.

In the above technical solution, by providing the inner surface of the first corner section with the first groove and accommodating at least a portion of the first adhesive tape in the first groove, the first adhesive tape can be prevented from protruding from the positive active material or a thickness of the portion protruding from the positive active material can be relatively small, thereby reducing the overall thickness of the first adhesive tape and the positive electrode plate, decreasing the overall volume of the electrode assembly, and improving the energy density of the cell.

In some embodiments of this application, the cell includes a second adhesive tape, and the second adhesive tape is attached to an outer surface of the first corner section. Along a winding direction of the cell, a length of the second adhesive tape is greater than that of the first adhesive tape.

In the above technical solution, since attaching the first adhesive tape to the inner surface of the first corner section will reduce the ductility of the inner surface of the first corner section, when the positive active material expands, the inner and outer surfaces of the first corner section experience uneven stress, which may cause the positive current collector of the first corner section to fracture. Moreover, after the fracture of the positive current collector, the positive active material on the inner surface of the first corner section may move to the outer surface of the first corner section through a crack, increasing the risk of metal ion precipitation. By including the second adhesive tape in the cell and attaching same to the outer surface of the first corner section, when the positive active material expands, more uniform stress distribution between the inner and outer surfaces of the first corner section can be ensured, reducing the possibility of fracture in the positive current collector of the first corner section. Moreover, when the positive current collector of the first corner section fractures, and the positive active material on the inner surface of the first corner section move to the outer surface of the first corner section through the crack, the second adhesive tape can mitigate the risk of metal ion precipitation from the positive active material on the outer surface of the first corner section, thereby enhancing the safety of the cell.

After the positive electrode plate is wound, an elongation length of the outer surface of the first corner section along the winding direction of the cell is greater than that of the inner surface. By making the length of the second adhesive tape greater than that of the first adhesive tape along the winding direction of the cell, an overlapping area of a projection of the second adhesive tape and a projection of the first adhesive tape is larger along the thickness direction of the positive electrode plate increases. This further enables more uniform stress distribution between the inner and outer surfaces of the first corner section during expansion of the positive active material, reducing the possibility of fracture in the positive current collector of the first corner section.

In some embodiments of this application, the electrode assembly includes two layers of the separator, and the two layers of the separators are respectively disposed on two sides of the negative electrode plate along a thickness direction thereof. The separator is connected to the negative electrode plate through thermal bonding, and an end face of the separator is aligned with an end face of the winding starting end of the negative electrode plate.

In the above technical solution, by configuring the electrode assembly to include two layers of separator, where the two layers of separator are respectively disposed on two sides of the negative electrode plate along a thickness direction thereof, the separators can isolate the positive electrode plate from the negative electrode plate, reducing the risk of short circuit between the positive electrode plate and the negative electrode plate and improving the safety of the cell.

Since the separator may shrink under heat during subsequent steps such as chemical formation of the cell, thermally bonding the separator to the negative electrode plate and aligning the end face of the separator with the end surface of the winding starting end of the negative electrode plate enable that it would not be easy to separate the end surface of the separator from the end surface of the winding starting end of the negative electrode plate after the separator is heated, so that the isolation effect of the separator between the positive electrode plate and the negative electrode plate is better, and the separator volume is smaller, the end of the separator would not be stacked at the winding center of the electrode assembly, which are conducive to minimizing the volume of the electrode assembly and increasing the energy density of the cell.

In some embodiments of this application, the electrode assembly includes two layers of the separator, and the two layers of the separators are respectively disposed on two sides of the negative electrode plate along a thickness direction thereof. Along an opposite direction of the winding of the cell, the two layers of the separators extend beyond the winding starting end of the negative electrode plate and are connected. The length of a portion of the separator extending beyond the winding starting end of the negative electrode plate is L2, satisfying 0 mm<L2≤20 mm.

In the above technical solution, since the separator may thermally shrink during subsequent steps such as chemical formation of the cell, by arranging two layers of separators to extend beyond the winding starting end of the negative electrode plate and connect along an opposite direction of cell winding, the winding starting end of the negative electrode plate can always be covered by the two layers of separators without exposure, reducing the possibility of short circuit between the negative electrode plate and the positive electrode plate, thereby improving the safety of the cell.

When L2 is greater than 0, the separator can provide a better isolation effect between the negative electrode plate and the positive electrode plate, reducing the possibility of short circuit between the negative electrode plate and the positive electrode plate, and improving safety of the cell. When L2 is less than or equal to 20 mm, the volume of the portion of the separator extending beyond the winding starting end of the negative electrode plate can be smaller, rendering the volume of the electrode assembly to be smaller, which is conducive to improving the energy density of the cell. Therefore, when 0 mm<L2≤20 mm, it not only ensures an better isolation effect of the separator between the negative electrode plate and the positive electrode plate, to reduce the possibility of short circuit of contact between the negative electrode plate and the positive electrode plate, and improve the cell safety, but also enables a smaller volume of the portion that the separator extends beyond the winding starting end of the negative electrode plate, rendering the volume of the electrode assembly to be smaller, which is conducive to improving the energy density of the cell.

In some embodiments of this application, the cell includes a negative tab, and the negative tab is riveted to the negative electrode plate.

In the above technical solution, since the welding mode requires forming an empty foil region on the negative electrode plate, by riveting the negative tab to the negative electrode plate, the step of forming the empty foil region on the negative electrode plate can be omitted, further improving the preparation efficiency of the cell.

In some embodiments of this application, the negative electrode plate has a first surface and a second surface oppositely arranged along the thickness direction thereof, and the negative electrode plate is provided with a through hole penetrating along the thickness direction thereof. The negative tab includes a main body and a riveting portion, the main body is disposed on the first surface, the riveting portion protrudes from the main body and penetrates the through hole, and an end that is of the riveting portion and that is away from the main body abuts against the second surface.

In the above technical solution, by including the main body and the riveting portion in the negative tab, with the main body disposed on the first surface, the riveting portion protruding from the main body and penetrating the through hole, and the end that is of the riveting portion and that is away from the main body abutting against the second surface, the riveting mode between the negative tab and the negative electrode plate is simple, easy to prepare, and can ensure a stable connection between the negative tab and the negative electrode plate. The negative tab is not easily detached from the negative electrode plate, the reliability of the cell is high, and tab connection can be achieved without removing the active material.

In a second aspect, this application provides an electrical device including the aforementioned cell, the cell being configured to provide electrical energy.

### BRIEF DESCRIPTION OF DRAWINGS

To describe technical solutions in embodiments of this application more clearly, the following outlines the drawings to be used in the embodiments. Understandably, the following drawings show merely some embodiments of this application, and therefore, are not intended to limit the scope. A person of ordinary skill in the art may derive other related drawings from the drawings.

FIG. 1 is a schematic cross-sectional structural diagram of an electrode assembly of a cell according to some embodiments of this application;

FIG. 2 is a schematic structural diagram of an unfolded negative electrode plate of the cell according to some embodiments of this application;

FIG. 3 is a schematic structural diagram of an unfolded positive electrode plate of the cell according to some embodiments of this application;

FIG. 4 is a schematic structural diagram of an unfolded positive electrode plate of the cell according to some other embodiments of this application;

FIG. 5 is a schematic enlarged diagram of a partial structure of the cell according to some other embodiments of this application;

FIG. 6 is a schematic cross-sectional structural diagram of the cell according to some other embodiments of this application;

FIG. 7 is a schematic structural diagram of an unfolded separator of the cell according to some other embodiments of this application;

FIG. 8 is a schematic cross-sectional structural diagram of the cell according to some other embodiments of this application;

FIG. 9 is a schematic cross-sectional diagram of a partial structure of the cell according to some embodiments of this application; and

FIG. 10 is a schematic structural diagram of an unfolded negative electrode plate according to some other embodiments of this application.

Reference numerals: 10—Electrode assembly; 100—Positive electrode plate; 101—First straight section; 102—First corner section; 1021—First groove; 1022—Second groove; 103—Second straight section; 100a—Double-sided coated region; 100b—Single-sided coated region; 100c—Double-sided empty foil region; 110—Positive current collector; 120—Positive active material; 200—Separator; 210—Base layer; 220—Bonding layer; 300—Negative electrode plate; 301—Third straight section; 302—Second corner section; 303—Fourth straight section; 300a—First surface; 300b—Second surface; 310—Negative current collector; 320—Negative active material; 330—Through hole; 410—First adhesive tape; 420—Second adhesive tape; 510—Negative tab; 511—Main body; 512—Riveting portion; 520—Positive tab; X—Thickness direction of the electrode assembly; Y—First direction; Z—Winding axis direction of the electrode assembly; A—Length direction after unfolding the positive electrode plate (negative electrode plate/separator); B—Thickness direction after unfolding the positive electrode plate (negative electrode plate/separator); and C—Width direction after unfolding the positive electrode plate (negative electrode plate/separator).

### DETAILED DESCRIPTION

In order to make objectives, technical solutions and advantages of this application clearer, the technical solutions in the embodiments of this application will be clearly described below in conjunction with drawings in the embodiments of this application. Apparently, the described embodiments are some rather than all of the embodiments of this application. Based on the embodiments in this application, all other embodiments derived by a person of ordinary skill in the art still fall within the scope of protection of this application.

Unless otherwise defined, all technical and scientific terms used in this application have the same meanings as commonly understood by a person skilled in the technical field of this application. The terms used in the specification of this application are merely for the purpose of describing specific embodiments and are not intended to limit this application. The terms “including” and “having” and any variations thereof in the description and claims of this application and in the description of the drawings above are intended to cover non-exclusive inclusion.

The terms “first”, “second”, and the like in the description and claims of this application or the preceding drawings are used to distinguish between different objects, not to describe a particular sequence or a primary-secondary relationship.

In this application, reference to “embodiment” means that specific features, structures or characteristics described with reference to the embodiment may be incorporated in at least one embodiment of this application. The occurrence of the phrase at various locations in the description does not necessarily all refer to the same embodiment, nor is it a separate or alternative embodiment that is mutually exclusive with other embodiments.

In the embodiments of this application, the same reference numerals indicate the same components, and for simplicity, in the different embodiments, a detailed description of the same components is omitted. It should be understood that the thickness, length, width, and other dimensions of the various components in the embodiments of this application, as well as the overall thickness, length, width, and other dimensions of an integrated device shown in the drawings, are merely exemplary illustrations and do not constitute any limitation on this application.

With the development of the new energy industry, batteries are gradually moving toward directions of higher energy density and higher power density. A negative active material of a battery generally includes materials such as graphite and silicon. Moreover, among them, silicon-based negative electrodes are further favored for higher energy density, but the higher expansion rate of the silicon-based negative electrodes can affect battery performance. For example, currently, the negative electrode plate in jelly-roll battery generally includes a double-sided coated region, a single-sided coated region, and a double-sided empty foil region. However, due to a high expansion force of the silicon-based negative electrodes, a difference in the expansion force among the double-sided coated region, single-sided coated region, and double-sided empty foil region becomes significant. This leads to uneven stress distribution between the double-sided coated region and the single-sided coated region, and between the single-sided coated region and the double-sided empty foil region, thereby causing fractures. As a result, metal ions are precipitated, affecting the battery's service life.

To improve the service life of the cell, this application provides a cell, the cell includes an electrode assembly. The electrode assembly is formed by winding a positive electrode plate, a separator, and a negative electrode plate which are stacked. The negative electrode plate includes a negative current collector and a negative active material, the negative active material includes a silicon-based material, and two surfaces of the negative current collector are configured to be completely coated with the negative active material. An innermost turn of the positive electrode plate includes a first straight section, a first corner section, and a second straight section, the first corner section connects the first straight section and the second straight section, and an end that is of the first straight section and that is away from the first corner section serves as a winding starting end of the positive electrode plate. The positive electrode plate includes a positive current collector and a positive active material, and in the first straight section, the first corner section, and the second straight section, two surfaces of the positive current collector are coated with the positive active material. An innermost turn of the negative electrode plate includes a third straight section, a second corner section, and a fourth straight section, the second corner section connects the third straight section and the fourth straight section, and an end that is of the third straight section and that is away from the second corner section serves as a winding starting end of the negative electrode plate. Along a thickness direction of the electrode assembly, the first straight section is located between the third straight section and the fourth straight section, and the third straight section is located between the first straight section and the second straight section.

In this structure of the cell, by enabling the negative electrode plate to include the negative current collector and the negative active material, and the negative active material to include the silicon-based material, the negative electrode material can accommodate more metal ions, rendering higher energy density of the cell. By completely coating the negative active material on two surfaces of the negative current collector, the difference in expansion forces exerted on various parts of the negative current collector is relatively small when the negative active material expands, which can reduce the possibility of fracture caused by uneven stress on the negative current collector, thereby decreasing the possibility of metal ion precipitation due to the fracture of the negative current collector, thereby being conducive to improving the service life of the cell. Moreover, the coating process of the negative active material does not require type change, which can enhance the efficiency of the coating process. Two surfaces of the negative current collector are configured to be completely coated with the negative active material. At the first straight section, the first corner section, and the second straight section, two surfaces of the positive current collector are coated with the positive active material. Along the thickness direction of the electrode assembly, the first straight section is located between the third straight section and the fourth straight section, and the third straight section is positioned between the first straight section and the second straight section, so that the positive active material in the first straight section and the second straight section, and the negative active material in the third straight section and the fourth straight section can all be used for intercalation and deintercalation of metal ions. As a result, the volume proportion of both the positive active material and the negative active material are increased, and the utilization rate is higher, thereby being conducive to improving the energy density of the cell.

The cell provided in the embodiments of this application may be a secondary battery or a primary battery, for example, a lithium-ion battery, sodium-ion battery, or magnesium-ion battery, etc., which is not limited in the embodiments of this application. The cell may be cylindrical, flat, cuboidal, or other shapes, which is not limited in the embodiments of this application, either.

The embodiments of this application provide an electrical device using a cell as a power source. The electrical device may be, but is not limited to, mobile phones, tablets, notebook computers, electric toys, electric tools, electric vehicles, automobiles, ships, spacecraft, etc.

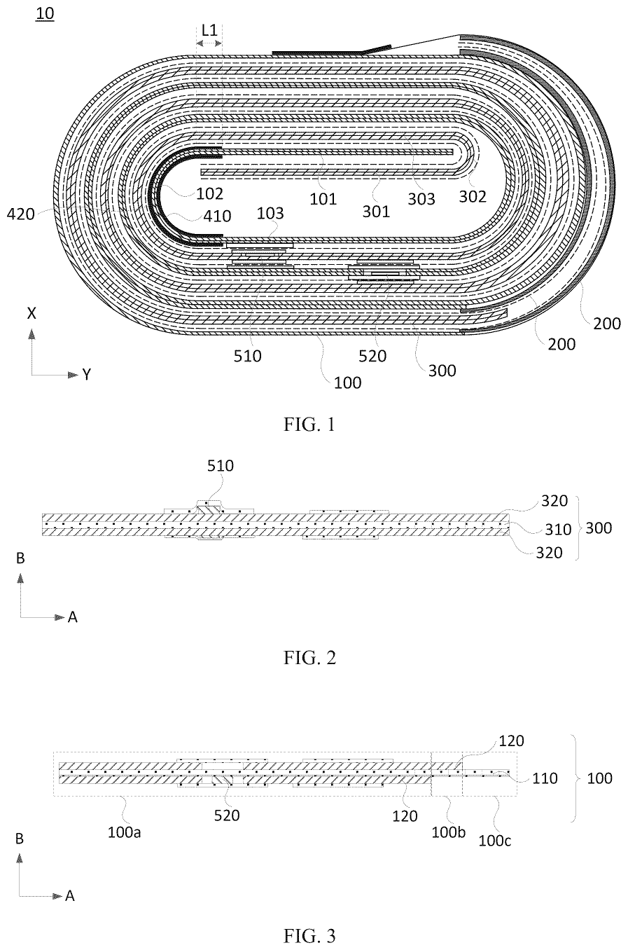

Referring to FIG. 1 and FIG. 2. FIG. 1 is a schematic cross-sectional structural diagram of an electrode assembly of a cell according to some embodiments of this application. FIG. 2 is a schematic structural diagram of an unfolded negative electrode plate of the cell according to some embodiments of this application.

The embodiment of this application provides a cell, the cell including an electrode assembly 10, and the electrode assembly 10 being formed by winding a positive electrode plate 100, a separator 200, and a negative electrode plate 300 which are stacked. The negative electrode plate 300 includes a negative current collector 310 and a negative active material 320, the negative active material 320 includes a silicon-based material, and two surfaces of the negative current collector 310 are configured to be completely coated with the negative active material 320.

By enabling the negative electrode plate 300 to include the negative current collector 310 and the negative active material 320, and the negative active material 320 to include the silicon-based material, the negative electrode material can accommodate more metal ions, rendering higher energy density of the cell. By completely coating the negative active material 320 on two surfaces of the negative current collector 310, the difference in expansion forces exerted on various parts of the negative current collector 310 is relatively small when the negative active material 320 expands, which can reduce the possibility of fracture caused by uneven stress on the negative current collector 310, thereby decreasing the possibility of metal ion precipitation due to the fracture of the negative current collector 310, thereby being conducive to improving the service life of the cell. Moreover, during the coating process of the negative active material 320, no type change is required, which can improve the efficiency of the coating process, where type change refers to that double-sided coating and single-sided coating correspond to different device types, and different types of devices need to be replaced for different coating modes.

In some embodiments, after the negative electrode plate 300 is prepared, part of the negative active material 320 is removed by laser or other modes to form an empty foil region for welding with the negative tab 510. While it does not affect the coating process of the negative active material 320, so this solution also falls within the scope of this application where the two surfaces of the negative current collector 310 are fully coated with the negative active material 320.

In some embodiments, the silicon-based material may include materials such as elemental silicon or silicon-containing compounds.

In some embodiments, an innermost turn of the positive electrode plate 100 includes a first straight section 101, a first corner section 102, and a second straight section 103, the first corner section 102 connects the first straight section 101 and the second straight section 103, and an end that is of the first straight section 101 and that is away from the first corner section 102 serves as a winding starting end of the positive electrode plate 100. The positive electrode plate 100 includes a positive current collector 110 and a positive active material 120, and in the first straight section 101, the first corner section 102, and the second straight section 103, two surfaces of the positive current collector 110 are coated with the positive active material 120. An innermost turn of the negative electrode plate 300 includes a third straight section 301, a second corner section 302, and a fourth straight section 303, the second corner section 302 connects the third straight section 301 and the fourth straight section 303, and an end that is of the third straight section 301 and that is away from the second corner section 302 serves as a winding starting end of the negative electrode plate 300. Along a thickness direction X of the electrode assembly, the first straight section 101 is located between the third straight section 301 and the fourth straight section 303, and the third straight section 301 is located between the first straight section 101 and the second straight section 103.

Two surfaces of the negative current collector 310 are configured to be completely coated with the negative active material 320. At the first straight section 101, the first corner section 102, and the second straight section 103, two surfaces of the positive current collector 110 are coated with the positive active material 120. Along the thickness direction X of the electrode assembly, the first straight section 101 is located between the third straight section 301 and the fourth straight section 303, and the third straight section 301 is positioned between the first straight section 101 and the second straight section 103, so that the positive active material 120 in the first straight section 101 and the second straight section 103 and the negative active material 320 in the third straight section 301 and the fourth straight section 303 can all be used for intercalation and deintercalation of metal ions. As a result, the volume proportions of both the positive active material 120 and negative active material 320 are increased, and the utilization rate is higher, thereby being conducive to improving the energy density of the cell.

In some embodiments, along the first direction Y, the winding starting end of the positive electrode plate 100 and the winding starting end of the negative electrode plate 300 are oriented toward opposite directions, forming an interdigitated structure between the winding starting end of the positive electrode plate 100 and the winding starting end of the negative electrode plate 300. This ensures that both the positive active material 120 at the winding starting end of the positive electrode plate 100 and the negative active material 320 at the winding starting end of the negative electrode plate 300 can be utilized, which is conducive to improving the energy density of the cell. Moreover, the interdigitated structure enhances the wrapping performance of the cell, further suppressing the expansion of the negative electrode plate 300.

The cell works primarily by relying on the movement of metal ions between the positive electrode plate 100 and the negative electrode plate 300. Taking the lithium-ion battery as an example, a material of the positive current collector 110 may be aluminum, and a positive active material 120 may be lithium cobalt oxide, lithium iron phosphate, ternary material, lithium manganese oxide, or the like. The material of the negative current collector 310 can be copper. The material of the separator 200 can be polypropylene (PP) or polyethylene (PE), etc.

In some embodiments, in the negative active material 320, a mass percentage content of the silicon-based material is 4%-100%. For example, the mass percentage content of the silicon-based material can be 4%, 50%, or 100%, etc.

In the above technical solution, by setting the mass percentage content of the silicon-based material in the negative active material 320 to be 4%-100%, the negative electrode material can accommodate more metal ions, thereby increasing the energy density of the cell.

When the mass percentage content of the silicon-based material in the negative active material 320 is less than 100%, the negative active material 320 may also include a carbon material, such as graphite. The expansion rate of the negative active material 320 can be reduced.

Referring to FIG. 3, FIG. 3 is a schematic structural diagram of an unfolded positive electrode plate of the cell according to some embodiments of this application.

In some embodiments, the positive electrode plate 100 includes a double-sided coated region 100a and a single-sided coated region 100b, one end of the double-sided coated region 100a serves as the winding starting end of the positive electrode plate 100, and the other end is connected to the single-sided coated region 100b. The single-sided coated region 100b is located on an outer side of an outermost turn of the negative electrode plate 300, and a side that is of the single-sided coated region 100b and that faces the negative electrode plate 300 is coated with the positive active material 120.

By making the positive electrode plate 100 include a double-sided coated region 100a and a single-sided coated region 100b, with one end of the double-sided coated region 100a serving as the winding starting end of the positive electrode plate 100 and the other end being connected to the single-sided coated region 100b, the positive active material 120 in the double-sided coated region 100a can cooperate with the corresponding negative active material 320 to achieve the intercalation and deintercalation of metal ions. The double-sided coated region 100a is conducive to increasing the volume proportion of the positive active material 120, thereby being conducive to improving the energy density of the cell. Since the single-sided coated region 100b is located on the outer side of the outermost turn of the negative electrode plate 300, and the positive active material 120 is disposed on the side that is of the single-sided coated region 100b and that faces the negative electrode plate 300, i.e., there is no negative active material 320 on the outer side of the single-sided coated region 100b, so the arrangement of the single-sided coated region 100b enables the positive active material 120 on the inner side of the single-sided coated region 100b to cooperate with the negative active material 320 located on the outer side of the outermost turn of the negative electrode plate 300 to achieve the intercalation and deintercalation of metal ions. Moreover, the absence of positive active material 120 on the outer side of the single-sided coated region 100b can improve the utilization rate of the positive active material 120 and can reduce the overall thickness of the cell, which is conducive to increasing the energy density of the cell.

In some embodiments, the positive electrode plate 100 further includes a double-sided empty foil region 100c, with one end of the double-sided empty foil region 100c being connected to the single-sided coated region 100b and the other end serving as a winding tail end of the positive electrode plate 100.

By enabling the positive electrode plate 100 to further include the double-sided empty foil region 100c, where one end of the double-sided empty foil region 100c is connected to the single-sided coated region 100b, and the other end serves as the winding tail end of the positive electrode plate 100, it can be conducive to winding up and securing through the double-sided empty foil region 100c.

Referring to FIG. 4, FIG. 4 is a schematic structural diagram of an unfolded positive electrode plate of the cell according to some other embodiments of this application.

In some embodiments, the positive electrode plate 100 includes the double-sided coated region 100a and the single-sided coated region 100b, one end of the double-sided coated region 100a serves as the winding starting end of the positive electrode plate 100, and the other end is connected to the single-sided coated region 100b. One end of the single-side coated region 100b is connected to the double-side coated region 100a, and the other end serves as the winding tail end of the positive electrode plate 100. The single-sided coated region 100b is located on the outer side of the outermost turn of the negative electrode plate 300.

Referring to FIG. 1, in some embodiments, the cell includes a first adhesive tape 410, and the first adhesive tape 410 is attached to an inner surface of the first corner section 102.

Since the first corner section 102 corresponds to the winding starting end of the negative electrode plate 300, the metal ions deintercalated from the positive active material 120 on the inner side of the first corner section 102 lack sufficient corresponding negative active material 320 for intercalation. Therefore, by including the first adhesive tape 410 in the cell and attaching the first adhesive tape 410 to the inner surface of the first corner section 102, the first adhesive tape 410 can cover the positive active material 120 on the inner side of the first corner section 102, reducing the possibility of metal ion precipitation at the first corner section 102, which is conducive to extending the service life of the cell. Moreover, the first adhesive tape 410 covers the inner side of the first corner section 102, which can mitigate the risk of powder shedding caused by bending at the first corner section 102. The first adhesive tape 410 can also provide insulation between the winding starting end of the negative electrode plate 300 and the first corner section 102, reducing the possibility of short circuit caused by contact between the negative electrode plate 300 and the positive electrode plate 100, which is conducive to improving the safety of the cell.

In some embodiments, the first adhesive tape 410 may include at least one material of epoxy resin, polypropylene, polyolefin, rubber, or the like.

In some embodiments, along the thickness direction X of the electrode assembly, a projection of the first adhesive tape 410 and a projection of the third straight section 301 have an overlap region.

By enabling the projection of the first adhesive tape 410 and the projection of the third straight section 301 to have the overlap region along the thickness direction X of the electrode assembly, the area of the positive active material 120 covered by the first adhesive tape 410 corresponding to the winding starting end of the negative electrode plate 300 is larger, thereby further reducing the possibility of metal ion precipitation in the first corner section 102, which is conducive to extending the service life of the cell.

In some embodiments, along the first direction Y, the length of the overlap region is L1, satisfying 2 mm≤L1≤5 mm. For example, L1 can be 2 mm, 3 mm, 5 mm, or the like.

The first direction Y, the thickness direction X of the electrode assembly, and the winding axis direction Z of the electrode assembly are mutually perpendicular.

When L1 is greater than or equal to 2 mm, the area of the positive active material 120 covered by the first adhesive tape 410 can be larger, further reducing the possibility of metal ion precipitation at the first corner section 102, which is conducive to prolonging the service life of the cell. When L1 is less than or equal to 5 mm, a space occupied by the first adhesive tape 410 can be smaller, thereby being conducive to reducing an overall volume of the electrode assembly 10 and improving the energy density of the cell. Therefore, when 2 mm≤L1≤5 mm, it can not only reduce the possibility of metal ion precipitation at the first corner section 102, which is conducive to extending the service life of the cell, but also improve the energy density of the cell.

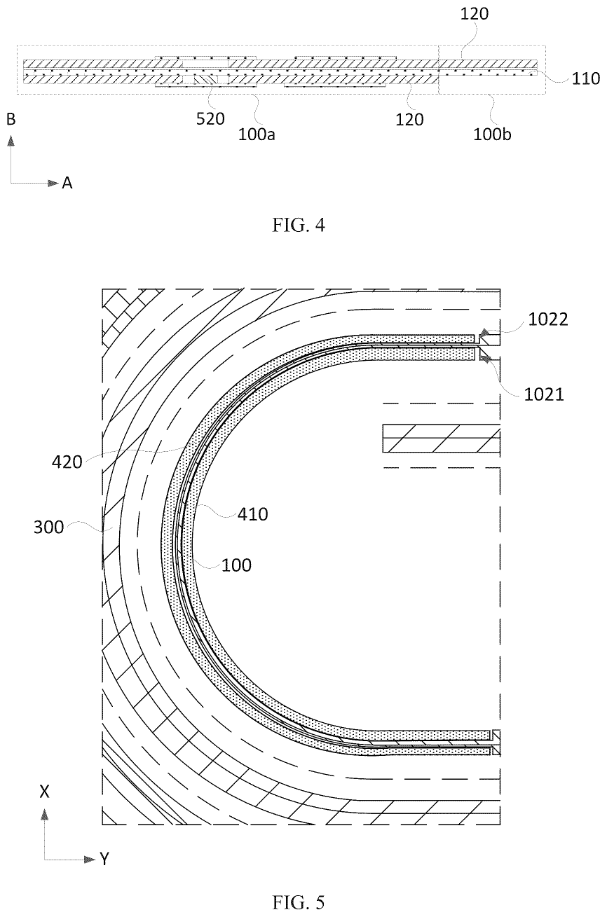

Referring to FIG. 5, FIG. 5 is a schematic enlarged diagram of a partial structure of the cell according to some other embodiments of this application.

In some embodiments, the inner surface of the first corner section 102 is provided with a first groove 1021, and at least a portion of the first adhesive tape 410 is accommodated in the first groove 1021.

By providing the inner surface of the first corner section 102 with the first groove 1021 and accommodating at least a portion of the first adhesive tape 410 in the first groove 1021, the first adhesive tape 410 can be prevented from protruding from the positive active material 120 or a thickness of the portion protruding from the positive active material 120 can be relatively small, thereby reducing the overall thickness of the first adhesive tape 410 and the positive electrode plate 100, decreasing the overall volume of the electrode assembly 10, and improving the energy density of the cell.

Referring to FIG. 1 and FIG. 5, in some embodiments, the cell includes a second adhesive tape 420, and the second adhesive tape 420 is attached to an outer surface of the first corner section 102.

Since attaching the first adhesive tape 410 to the inner surface of the first corner section 102 will reduce the ductility of the inner surface of the first corner section 102, when the positive active material 120 expands, the inner and outer surfaces of the first corner section 102 experience uneven stress, which may cause the positive current collector 110 of the first corner section 102 to fracture. Moreover, after the fracture of the positive current collector 110, the positive active material 120 on the inner surface of the first corner section 102 may move to the outer surface of the first corner section 102 through a crack, increasing the risk of metal ion precipitation. By including the second adhesive tape 420 in the cell and attaching same to the outer surface of the first corner section 102, when the positive active material 120 expands, more uniform stress distribution between the inner and outer surfaces of the first corner section 102 can be ensured, reducing the possibility of fracture in the positive current collector 110 of the first corner section 102. Moreover, when the positive current collector 110 of the first corner section 102 fractures, and the positive active material 120 on the inner surface of the first corner section 102 move to the outer surface of the first corner section 102 through the crack, the second adhesive tape 420 can mitigate the risk of metal ion precipitation from the positive active material 120 on the outer surface of the first corner section 102, thereby enhancing the safety of the cell.

In some embodiments, along a winding direction of the cell, a length of the second adhesive tape 420 is greater than that of the first adhesive tape 410. For example, the length of the second adhesive tape 420 may be 1.1 times, 1.3 times, or 1.5 times the length of the first adhesive tape 410.

After the positive electrode plate 100 is wound, an elongation length of the outer surface of the first corner section 102 along the winding direction of the cell is greater than that of the inner surface. By making the length of the second adhesive tape 420 greater than that of the first adhesive tape 410 along the winding direction of the cell, an overlapping area of a projection of the second adhesive tape 420 and a projection of the first adhesive tape 410 is larger along the thickness direction of the positive electrode plate increases. This further enables more uniform stress distribution between the inner and outer surfaces of the first corner section 102 during expansion of the positive active material 120, reducing the possibility of fracture in the positive current collector 110 of the first corner section 102.

In some embodiments, the second adhesive tape 420 may include at least one of epoxy resin, polypropylene, polyolefin, rubber, or other materials.

In some embodiments, in the thickness direction of the positive current collector 110, the projections of the first adhesive tape 410 and the second adhesive tape 420 overlap. This can further ensure that the inner and outer surfaces of the first corner section 102 are subjected to more uniform stress, reducing the possibility of fracture in the positive current collector 110 of the first corner section 102.

In some embodiments, the outer surface of the first corner section 102 is provided with a second groove 1022, and at least a portion of the second adhesive tape 420 is accommodated in the second groove 1022.

By providing the outer surface of the first corner section 102 with the second groove 1022 and accommodating at least a portion of the second adhesive tape 420 in the second groove 1022, the second adhesive tape 420 can be prevented from protruding beyond the positive active material 120 or a thickness of the portion protruding from the positive active material 120 can be relatively small, thereby reducing the overall thickness of the second adhesive tape 420 and the positive electrode plate 100, decreasing the overall volume of the electrode assembly 10, and improving the energy density of the cell.

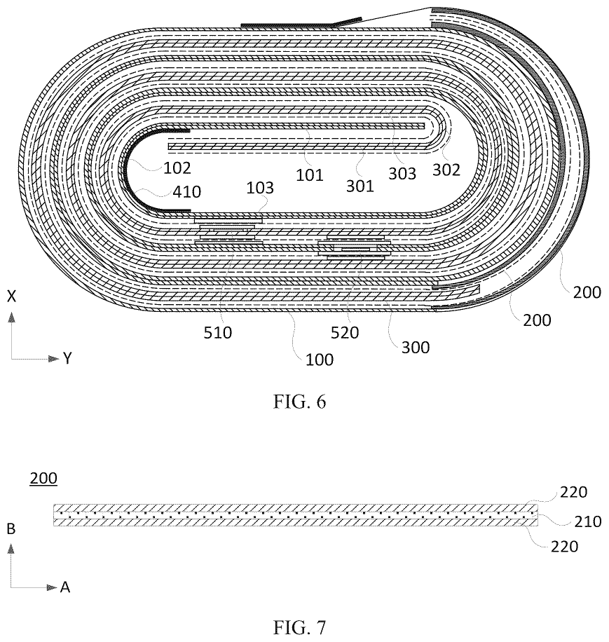

Referring to FIG. 6, FIG. 6 is a schematic cross-sectional structural diagram of the cell according to some other embodiments of this application.

In some other embodiments, the first corner section 102 may only be provided with the first adhesive tape 410, which can reduce the thickness of the positive electrode plate 100 and is conducive to improving the energy density of the cell.

Referring to FIG. 1, in some embodiments, the electrode assembly 10 includes two layers of the separators 200, and the two layers of the separators 200 are respectively disposed on two sides of the negative electrode plate 300 along a thickness direction thereof.

By configuring the electrode assembly 10 to include two layers of separators 200, where the two layers of separators 200 are respectively disposed on two sides of the negative electrode plate 300 along the thickness direction thereof, the separators 200 can isolate the positive electrode plate 100 from the negative electrode plate 300, reducing the risk of short circuit between the positive electrode plate 100 and the negative electrode plate 300, and improving the safety of the cell.

Referring to FIG. 7, FIG. 7 is a schematic structural diagram of an unfolded separator of the cell according to some other embodiments of this application.

In some embodiments, the separator 200 includes a base layer 210 and two bonding layers 220, and the two bonding layers 220 are respectively disposed on both sides of the base layer 210 along a thickness direction thereof.

By configuring the separator 200 to include a base layer 210 and two bonding layers 220, and the two bonding layers 220 being respectively disposed on both sides of the base layer 210 along the thickness direction thereof, the two bonding layers 220 can be used for bonding with the positive electrode plate 100 and the negative electrode plate 300, respectively. Displacement of the positive electrode plate 100 with respect to the separator 200 and displacement of the negative electrode plate 300 with respect to the separator 200 can be reduced, thereby enhancing the overall structure stability of the electrode assembly 100.

In some embodiments, the base layer 210 may include a polyethylene material, and the bonding layer 220 may include a polyvinylidene difluoride material.

By making the base layer 210 include a polyethylene material, the support strength of the base layer 210 can be enhanced, and stability thereof can be improved. By making the bonding layer 220 include a polyvinylidene difluoride material, the bonding force of the bonding layer 220 can be enhanced.

In some embodiments, the thickness of the base layer 210 is 4 μm to 6 μm. For example, the thickness of the base layer 210 can be 4 μm, 5 μm, or 6 μm.

When the thickness of the base layer 210 is greater than or equal to 4 μm, the support strength of the base layer 210 can be enhanced, the stability thereof is improved, the possibility of deformation of the separator 200 can be reduced, and the overall structure of the electrode assembly 100 can be more stable. When the thickness of the base layer 210 is less than or equal to 6 μm, the space occupation of the base layer 210 can be reduced, thereby reducing the volume of the electrode assembly 100, which is conducive to improving the energy density of the cell. Therefore, when the thickness of the base layer 210 is 4 μm to 6 μm, it not only enhances the supporting force and stability of the base layer 210, reduces the possibility of deformation in the separator 200, and improves the overall structure stability of the electrode assembly 100, but also reduces the space occupied by the base layer 210, thereby reducing the volume of the electrode assembly 100, which is conducive to improving the energy density of the cell.

In some embodiments, the thickness of the bonding layer 220 is 0.5 μm to 1.5 μm. For example, the thickness of the bonding layer 220 can be 0.5 μm, 1 μm, or 1.5 μm.

When the thickness of the bonding layer 220 is greater than or equal to 0.5 μm, the bonding force of the bonding layer 220 is improved, the possibility of displacement of the positive electrode plate 100 and the negative electrode plate 300 with respect to the separator 200 is reduced, and the overall structure stability of the electrode assembly 100 is enhanced. When the thickness of the bonding layer 220 is less than or equal to 1.5 μm, the space occupied by the bonding layer 220 can be reduced, thereby reducing the volume of the electrode assembly 100, which is conducive to improving the energy density of the cell. Therefore, when the thickness of the bonding layer 220 is 0.5 μm to 1.5 μm, it not only enhances the bonding force of the bonding layer 220, reduces the possibility of displacement of the positive electrode plate 100 and the negative electrode plate 300 with respect to the separator 200, stabilizes the overall structure of the electrode assembly 100, but also reduces the space occupied by the bonding layer 220, thereby reducing the volume of the electrode assembly 100, which is conducive to improving the energy density of the cell.

In some other embodiments, the electrode assembly 10 includes two layers of separators 200, the two layers of separators 200 are respectively disposed on two sides of the positive electrode plate 100 along a thickness direction thereof.

Referring to FIG. 1, in some embodiments, the separator 200 is thermally bonded to the negative electrode plate 300, and the end face of the separator 200 is aligned with the end face of the winding starting end of the negative electrode plate 300.

Where along the first direction Y, a distance of less than or equal to 0.5 mm between the end face of the separator 200 and the end face of the winding starting end of the negative electrode plate 300 is considered within the range of alignment between the end face of the separator 200 and the end face of the winding starting end of the negative electrode plate 300.

Since the separator 200 may shrink under heat during subsequent steps such as chemical formation of the cell, thermally bonding the separator 200 to the negative electrode plate 300 and aligning the end face of the separator 200 with the end surface of the winding starting end of the negative electrode plate 300 enable that it would not be easy to separate the end surface of the separator 200 from the end surface of the winding starting end of the negative electrode plate 300 after the separator 200 is heated, so that the isolation effect of the separator 200 between the positive electrode plate 100 and the negative electrode plate 300 is better, the separator 200 volume is smaller, the end of the separator 200 would not be stacked at the winding center of the electrode assembly 10, which are conducive to minimizing the volume of the electrode assembly 10 and increasing the energy density of the cell.

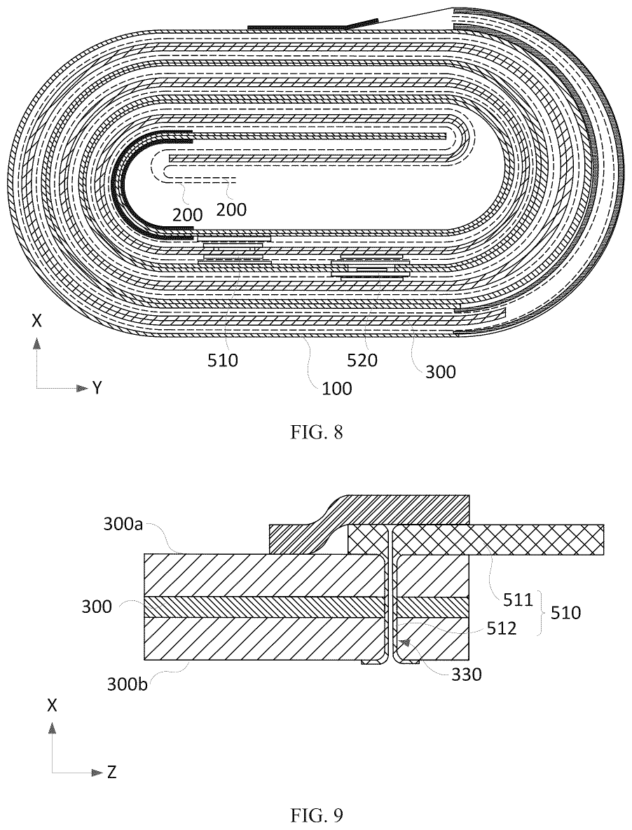

Referring to FIG. 8, FIG. 8 is a schematic cross-sectional structural diagram of the cell according to some other embodiments of this application.

In some embodiments, along an opposite direction of the winding of the cell, the two layers of the separators 200 extend beyond the winding starting end of the negative electrode plate 300 and are connected. In this embodiment, the separator 200 and the negative electrode plate 300 may be thermally bonded or arranged by stacking.

Since the separator 200 may thermally shrink during subsequent steps such as chemical formation of the cell, by arranging two layers of separators 200 to extend beyond the winding starting end of the negative electrode plate 300 and connect along an opposite direction of cell winding, the winding starting end of the negative electrode plate 300 can always be covered by the two layers of separators 200 without exposure, reducing the possibility of short circuit between the negative electrode plate 300 and the positive electrode plate 100, thereby improving the safety of the cell.

In some embodiments, the length of a portion of the separator 200 extending beyond the winding starting end of the negative electrode plate 300 is L2, satisfying 0 mm<L2≤20 mm. For example, L2 can be 1 mm, 10 mm, or 20 mm, etc.

When L2 is greater than 0, the separator 200 can provide a better isolation effect between the negative electrode plate 300 and the positive electrode plate 100, reducing the possibility of short circuit between the negative electrode plate 300 and the positive electrode plate 100, and improving safety of the cell. When L2 is less than or equal to 20 mm, the volume of the portion of the separator 200 extending beyond the winding starting end of the negative electrode plate 300 can be reduced, thereby reducing the volume of the electrode assembly 10, which is conducive to improving the energy density of the cell. Therefore, when 0 mm<L2≤20 mm, it not only ensures an better isolation effect of the separator 200 between the negative electrode plate 300 and the positive electrode plate 100, to reduce the possibility of short circuit of contact between the negative electrode plate 300 and the positive electrode plate 100, and improve the cell safety, but also enables a smaller volume of the portion that the separator 200 extends beyond the winding starting end of the negative electrode plate 300, rendering the volume of the electrode assembly 10 to be smaller, which is conducive to improving the energy density of the cell.

Referring to FIG. 1, FIG. 2 and FIG. 9, FIG. 9 is a schematic cross-sectional diagram of a partial structure of the cell according to some embodiments of this application.

In some embodiments, the cell 10 includes a negative tab 510, and the negative tab 510 is riveted to the negative electrode plate 300.

Since the welding mode requires forming an empty foil region on the negative electrode plate 300, by riveting the negative tab 510 to the negative electrode plate 300, the step of forming the empty foil region on the negative electrode plate 300 can be omitted, further improving the preparation efficiency of the cell.

In some embodiments, the negative electrode plate 300 has a first surface 300a and a second surface 300b oppositely arranged along the thickness direction thereof, and the negative electrode plate 300 is provided with a through hole 330 penetrating along the thickness direction thereof. The negative tab 510 includes a main body 511 and a riveting portion 512, the main body 511 is disposed on the first surface 300a, the riveting portion 512 protrudes from the main body 511 and penetrates the through hole 330, and an end that is of the riveting portion 512 and that is away from the main body 511 abuts against the second surface 300b.

By including the main body 511 and the riveting portion 512 in the negative tab 510, with the main body 511 disposed on the first surface 300a, the riveting portion 512 protruding from the main body 511 and penetrating the through hole 330, and the end that is of the riveting portion 512 and that is away from the main body 511 abutting against the second surface 300b, the riveting mode between the negative tab 510 and the negative electrode plate 300 is simple, easy to prepare, and can ensure a stable connection between the negative tab 510 and the negative electrode plate 300. The negative tab 510 is not easily detached from the negative electrode plate 300, the reliability of the cell is high, and tab connection can be achieved without removing the active material.

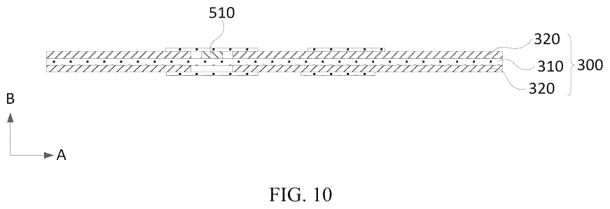

Referring to FIG. 10, FIG. 10 is a schematic structural diagram of an unfolded negative electrode plate according to some other embodiments of this application.

In some other embodiments, the negative tab 510 is welded to the negative electrode plate 300. A slot can be formed by laser cleaning on the negative electrode plate 300 to expose the negative current collector 310 at the slot, and then the negative tab 510 is welded to the negative electrode plate 300 via ultrasonic welding.

Referring to FIG. 1 and FIG. 3, in some embodiments, the cell includes a positive tab 520, and the positive tab 520 is welded to the positive electrode plate 100. A slot can be formed by laser cleaning on the double-side coated region 100a of the positive electrode plate 100, exposing the positive current collector 110 at the slot, and then the positive tab 520 is welded to the positive electrode plate 100 by ultrasonic welding.

In some other embodiments, the positive tab 520 and the positive electrode plate 100 may be riveted.

In some embodiments, the cell further includes a shell or packaging bag (not shown in the drawings), and the electrode assembly 10 is accommodated within the shell or the packaging bag.

In some embodiments, the packaging bag may be an aluminum laminated film, steel-plastic film, or the like.

In some embodiments, the shell may be made of a high-strength material, such as iron, aluminum alloy, or other metal materials, so that the shell has high load-bearing performance, thereby making the shell less prone to deformation or damage due to stress or environmental changes, which can further improve the reliability of the cell.

In some other embodiments, the shell may also be a non-metal material with high strength such as carbon fiber or hard plastic.

In some embodiments, the cell further includes an electrolyte solution, and the shell or packaging bag is used for accommodating the electrode assembly 10 and the electrolyte solution.

In some embodiments, the electrolyte solution may include an organic solvent, electrolyte lithium salt, etc.

In some embodiments, the preparation method of the cell includes:

S1, providing a negative current collector, and completely coating a negative active material on both surfaces of the negative current collector through continuous coating to form a negative electrode plate; and cold-pressing the negative electrode plate and slitting same to form small rolls of negative electrode plate.

S2, connecting the negative tab to the negative electrode plate by riveting.

Since ultrasonic welding can only be achieved in the empty foil region of the electrode plate, and the region coated with the active material cannot achieve ultrasonic welding, the first empty foil region is currently formed on the negative electrode plate through intermittent coating or laser etching to connect the negative tab with the first empty foil region. In this application, the negative tab is connected to the negative electrode plate by riveting, eliminating the need to form an empty foil region on the negative electrode plate, which can make the preparation process of the electrode assembly simpler and is conducive to reducing preparation costs.

S3, providing a positive current collector, coating the positive active material on both surfaces of the positive current collector respectively to form a positive electrode plate which includes a double-sided coated region, a single-sided coated region, and a double-sided empty foil region; and cold-pressing the positive electrode plate and slitting same to form small rolls of positive electrode plates.

S4, forming a second empty foil region on the double-sided coated region of the positive electrode plate by laser etching, and connecting the positive tab with the negative tab through ultrasonic welding.

S5, providing two separators, arranging the two separators on both sides of the negative electrode plate along the thickness direction thereof, and aligning the end faces of the separators with the end face of the winding starting end of the negative electrode plate; activating the two bonding layers on both sides of the base layer of the separator through thermal bonding, so that the bonding layers is bonded to the negative electrode plate.

S6, winding the positive electrode plate and the negative electrode plate in opposite directions, with the winding starting end of the positive electrode plate serving as the double-sided coated region; and providing a first adhesive tape on an inner surface of the positive electrode plate corresponding to the first corner section, and providing a second adhesive tape on an outer surface of the positive electrode plate corresponding to the first corner section.

S7, using the double-sided empty foil region of the positive electrode plate as the winding tail end of the electrode assembly, and providing an adhesive tape at the winding tail end of the electrode assembly.

S8, providing a packaging bag to accommodate the wound electrode assembly in the packaging bag, and then completing the steps such as electrolyte injection and chemical formation to produce the finished cell.

An embodiment of this application provides an electrical device, including the aforementioned cell. The cell is configured to provide electrical energy.

The electrical device may be any device or system that utilizes the aforementioned cell.

It is hereby noted that to the extent that no conflict occurs, the embodiments of this application and the features in the embodiments may be combined with each other.

The above are only optional embodiments of this application, and are not intended to limit this application, and this application is subject to various changes and variations for a person skilled in the art. Any modifications, equivalent replacements, improvements, and the like made within the spirit and principles of this application still fall within the scope of protection of this application.

What is claimed is:

1. A cell, wherein the cell comprises an electrode assembly; the electrode assembly comprises a positive electrode plate, a separator, and a negative electrode plate stacked together and wound to form the electrode assembly;
the negative electrode plate comprises a negative current collector and a negative active material, the negative active material comprises a silicon-based material, and two surfaces of the negative current collector are completely coated with the negative active material;
an innermost turn of the positive electrode plate comprises a first straight section, a first corner section, and a second straight section, the first corner section connects the first straight section and the second straight section, and an end of the first straight section arranged away from the first corner section serves as a winding starting end of the positive electrode plate;
the positive electrode plate comprises a positive current collector and a positive active material; in the first straight section, the first corner section, and the second straight section, two surfaces of the positive current collector are coated with the positive active material;
an innermost turn of the negative electrode plate comprises a third straight section, a second corner section, and a fourth straight section; the second corner section connects the third straight section and the fourth straight section, and an end of the third straight section arranged away from the second corner section serves as a winding starting end of the negative electrode plate; and
along a thickness direction of the electrode assembly, the first straight section is located between the third straight section and the fourth straight section, and the third straight section is located between the first straight section and the second straight section.

2. The cell according to claim 1, wherein in the negative active material, a mass percentage of the silicon-based material is 4%-100%.

3. The cell according to claim 1, wherein the positive electrode plate comprises a double-sided coated region and a single-sided coated region, one end of the double-sided coated region serves as the winding starting end of the positive electrode plate, and the other end is connected to the single-sided coated region; and the single-sided coated region is located on an outer side of an outermost turn of the negative electrode plate, and a side of the single-sided coated region facing the negative electrode plate is coated with the positive active material.

4. The cell according to claim 3, wherein the positive electrode plate further comprises a double-sided empty foil region, one end of the double-sided empty foil region is connected to the single-sided coated region, and the other end of the double-sided empty foil region serves as the winding tail end of the positive electrode plate.

5. The cell according to claim 1, wherein the cell comprises a first adhesive tape, and the first adhesive tape is attached to an inner surface of the first corner section.

6. The cell according to claim 5, wherein, along the thickness direction of the electrode assembly, a projection of the first adhesive tape and a projection of the third straight section have an overlap region;
along a first direction, a length of the overlap region is L1, satisfying 2 mm≤L1≤5 mm; and
the first direction, the thickness direction of the electrode assembly, and a winding axis direction of the electrode assembly are mutually perpendicular.

7. The cell according to claim 5, wherein the inner surface of the first corner section is provided with a first groove, and at least a portion of the first adhesive tape is accommodated in the first groove.

8. The cell according to claim 5, wherein the cell comprises a second adhesive tape, and the second adhesive tape is attached to an outer surface of the first corner section; and
along a winding direction of the cell, a length of the second adhesive tape is greater than a length of the first adhesive tape.

9. The cell according to claim 1, wherein the electrode assembly comprises two layers of the separator, and the two layers of the separators are respectively disposed on two sides of the negative electrode plate along a thickness direction of the negative electrode plate; and the separator is configured to connect to the negative electrode plate through thermal bonding, and an end face of the separator is configured to align with an end face of the winding starting end of the negative electrode plate.

10. The cell according to claim 1, wherein the electrode assembly comprises two layers of the separator, and the two layers of the separators are respectively disposed on two sides of the negative electrode plate along the thickness direction of the negative electrode plate; and
along an opposite direction of the winding of the cell, the two layers of the separators extend beyond the winding starting end of the negative electrode plate, and the two layers of the separators are connected; and
a length of a portion of the separator extending beyond the winding starting end of the negative electrode plate is L2, satisfying 0 mm<L2≤20 mm.

11. The cell according to claim 1, wherein the cell comprises a negative tab, and the negative tab is rivetted to the negative electrode plate.

12. The cell according to claim 11, wherein the negative electrode plate comprises a first surface and a second surface oppositely arranged along the thickness direction of the negative electrode plate, and the negative electrode plate is provided with a through hole penetrating along the thickness direction of the negative electrode plate; and
the negative tab comprises a main body and a riveting portion, the main body is disposed on the first surface, the riveting portion protrudes from the main body and penetrates the through hole, and an end of the riveting portion arranged away from the main body abuts against the second surface.

13. An electrical device, wherein the electrical device comprises the cell according to claim 1, the cell is configured to provide electrical energy.

14. The electrical device according to claim 13, wherein in the negative active material, a mass percentage of the silicon-based material is 4%-100%.

15. The electrical device according to claim 13, wherein the positive electrode plate comprises a double-sided coated region and a single-sided coated region, one end of the double-sided coated region serves as the winding starting end of the positive electrode plate, and the other end is connected to the single-sided coated region; and the single-sided coated region is located on an outer side of an outermost turn of the negative electrode plate, and a side of the single-sided coated region facing the negative electrode plate is coated with the positive active material.

16. The electrical device according to claim 15, wherein the positive electrode plate further comprises a double-sided empty foil region, one end of the double-sided empty foil region is connected to the single-sided coated region, and the other end of the double-sided empty foil region serves as the winding tail end of the positive electrode plate.

17. The electrical device according to claim 13, wherein the cell comprises a first adhesive tape, and the first adhesive tape is attached to an inner surface of the first corner section.

18. The electrical device according to claim 17, wherein, along the thickness direction of the electrode assembly, a projection of the first adhesive tape and a projection of the third straight section have an overlap region;
along a first direction, a length of the overlap region is L1, satisfying 2 mm≤L1≤5 mm; and
the first direction, the thickness direction of the electrode assembly, and a winding axis direction of the electrode assembly are mutually perpendicular.

19. The electrical device according to claim 17, wherein the inner surface of the first corner section is provided with a first groove, and at least a portion of the first adhesive tape is accommodated in the first groove.

20. The electrical device according to claim 17, wherein the cell comprises a second adhesive tape, and the second adhesive tape is attached to an outer surface of the first corner section; and
along a winding direction of the cell, a length of the second adhesive tape is greater than a length of the first adhesive tape.
